(19) United States
(12) Patent Application Publication
(10) Pub. No.: US 2007/0182519 A1
(43) Pub. Date: Aug. 9, 2007

(54) Laminated coil

(75) Inventors: Keiichi Tsuzuki, Shiga-ken-ken (JP); Tatsuya Mizuno, Shig-ken (JP)

Correspondence Address: MURATA MANUFACTURING COMPANY, LTD.;C/O KEATING & BENNETT, LLP, 8180 GREENSBORO DRIVE, SUITE 850, MCLEAN, VA, 22102, US

(73) Assignee: MURATA MANUFACTURING CO., LTD., (JP)

(21) Appl. No.: 10/597,014

(22) PCT Filed: May 31, 2005
(86) PCT No.: PCT/JP05/09975

§ 371 Date: Jul. 6, 2006

(30) Foreign Application Priority Data
Jun. 7, 2004 (JP) 2004-168569

(51) Int. Cl. H01F 5/00

(52) U.S. Cl. 336/200

(57) ABSTRACT

A laminated coil includes a non-magnetic body section inside a laminated body. On the non-magnetic body section, a coil conductor is provided. The number of coil turns of the coil conductor is greater than the number of coil turns of a coil conductor other than the coil conductor on the non-magnetic body section.

### TECHNICAL FIELD

The present invention relates to a laminated coil and, more specifically, relates to a laminated coil having an excellent direct current (DC) superimposition characteristic.

### BACKGROUND ART

A laminated coil is produced by stacking magnetic sheets each composed of ferrite or the like and provided with a coil conductor consisting primarily of Ag. Such a laminated coil is used in various circuits. The laminated coil is characteristic in that effective magnetic permeability is increased and a high inductance value is obtained because a closed magnetic path is formed by the magnetic field that is generated by an electrical current flowing through the coil conductors. The laminated coil is also advantageous in that loss due to the conductor resistance is small because the conductor patterns primarily consist of Ag. Thus, the laminated coil is used as a choke coil for a switching power supply to which a high current is applied.

For coil elements, the relationship between the current value applied to the coil conductors and the inductance value is represented as a DC superimposition characteristic. For a laminated coil having a closed magnetic path, there is a problem in that the desired choke coil characteristic cannot be obtained because the inductance value suddenly decreases when the current exceeds a predetermined value. This degradation of the DC superimposition characteristic is caused by magnetic saturation in the magnetic body generated because the laminated coil forms a closed magnetic path.

To solve the above-identified problem, the laminated coil described in Patent Document 1 has a structure in which non-magnetic body layers are provided inside the laminated coil composed of ferromagnetic layers. By employing the structure described in Patent Document 1, a close magnetic path is less likely formed inside the magnetic body since the magnetic fluxes from the non-magnetic body layers leak outside the laminated coil. Thus, magnetic saturation does not easily occur, and the DC superimposition characteristic is improved.

However, according to the structure of Patent Document 1, the amount of magnetic fluxes that leaks from the non-magnetic body layers is limited because the coil conductors provided on the non-magnetic body layers and the coil conductors provided on the ferromagnetic layers have the same shape and coil number. Therefore, when the value of the electric current flowing through the coil conductors is increased, the DC superimposition characteristic may be degraded.
Patent Document 1: Japanese Unexamined Patent Application Publication No. 2001-44036

### DISCLOSURE OF INVENTION

### Problems to be Solved by the Invention

The present invention provides a laminated coil that has an excellent DC superposition characteristic in which magnetic saturation is less likely to occur inside the laminated coil, the inductance value does not change even when a high electric current is applied.

### Means For Solving the Problems

To solve the above-identified problem, the laminated coil according to the present invention includes a laminated body having magnetic body sections disposed on both main surfaces of a non-magnetic body section, the magnetic body sections each being formed by stacking a plurality of magnetic layers, the non-magnetic body section being formed by stacking a plurality of non-magnetic layers, and a coil including coil conductors provided on the magnetic body sections and the non-magnetic body section, the coil conductors being helically connected. The coil number of the coil conductors provided on the non-magnetic body section is greater than the coil number of the coil conductors provided on layers other than the layers including the coil conductors provided on the non-magnetic body section.

According to the structure according to the present invention, the coil number of the coil conductors provided on the non-magnetic body section is greater than the coil number of the coil conductors provided on the other layers. Thus, the amount of magnetic fluxes leaking from the non-magnetic body sections is increased. Accordingly, a laminated coil having an excellent DC superposition characteristic in which the inductance value is not reduced even when a high electric current is applied to the coil conductors is obtained.

According to the present invention, the coil conductors provided on the non-magnetic body section are disposed on a main surface of the non-magnetic body section.

According to the structure according to the present invention, the amount of magnetic fluxes leaking from the non-magnetic body section can be increased by setting the coil number of the coil conductors provided on a main surface of the non-magnetic body sections greater than the coil number of the coil conductors provided on the other layers. Accordingly, a laminated coil having an excellent DC superposition characteristic in which the inductance value is not reduced even when a high electric current is applied to the coil conductors is obtained.

According to the present invention, the coil conductors provided on the non-magnetic body section are disposed on both main surfaces of the non-magnetic body section.

According to the structure according to the present invention, the amount of magnetic fluxes leaking from the non-magnetic body section can be increased by setting the coil number of the coil conductors provided on both main surfaces of the non-magnetic body sections greater than the coil number of the coil conductors provided on the other layers. Accordingly, the DC superposition characteristic of the laminated coil can be improved.

According to the present invention, the coil conductors provided on the non-magnetic body section are provided inside the non-magnetic body section.

According to the structure according to the present invention, the coil conductors are inside the non-magnetic body section. According to this structure, the strength of the magnetic field generated in the vicinity of the non-magnetic body section can be increased and the amount of magnetic fluxes leaking from the non-magnetic body section to the outside of the laminated coil can be increased. Accordingly, the DC superposition characteristic of the laminated coil can be improved.

According to the present invention, the coil conductors provided on the non-magnetic body section are provided on a main surface of the non-magnetic body section and inside the non-magnetic body section.

According to the structure according to the present invention, the coil number of the coil conductors provided on the non-magnetic body section is greater than the coil number of the coil conductors provided on the other layers and coil conductors are also provided inside the non-magnetic body section. According to this structure, the strength of the magnetic field generated in the vicinity of the non-magnetic body section can be increased and the amount of magnetic fluxes leaking from the non-magnetic body section to the outside of the laminated coil can be increased. Accordingly, the DC superposition characteristic of the laminated coil can be improved.

According to the present invention, a plurality of the non-magnetic body sections is provided inside the laminated body.

According to the structure according to the present invention, a plurality of the non-magnetic body sections is provided inside the laminated body. Thus, the amount of magnetic fluxes leaking from the non-magnetic body section to the outside of the laminated coil can be increased, and the DC superposition characteristic of the laminated coil can be improved.

Advantages

The laminated coil according to the present invention includes a laminated body having magnetic body sections disposed on both main surfaces of a non-magnetic body section, the magnetic body sections each being formed by stacking a plurality of magnetic layers, the non-magnetic body section being formed by stacking a plurality of non-magnetic layers, and a coil including coil conductors provided on the magnetic body sections and the non-magnetic body section, the coil conductors being helically connected. Moreover, the coil number of the coil conductors provided on the non-magnetic body section is greater than the coil number of the coil conductors provided on layers other than the layers including the coil conductors provided on the non-magnetic body section. Thus, the amount of magnetic fluxes leaking from the non-magnetic body section to the outside of the laminated coil can be increased. In this way, a laminated coil that has an excellent DC superposition characteristic in which magnetic saturation is less likely to occur inside the laminated coil, the inductance value does not change even when a high electric current is applied can be obtained. Accordingly, the characteristics of the laminated coil as a choke coil can be improved.

### BREIF DESCRIPTION OF THE DRAWINGS

FIG. 1 is an external schematic view of a laminated coil according to a first embodiment.

FIG. 2 is schematic cross-sectional view of a laminated coil according to a first embodiment.

FIG. 3 is an exploded perspective view of a laminated coil according to a first embodiment.

FIG. 4 is schematic cross-sectional view of a laminated coil according to a second embodiment.

FIG. 5 is an exploded perspective view of a laminated coil according to a second embodiment.

FIG. 6 is schematic cross-sectional view of a laminated coil according to a third embodiment.

FIG. 7 is a graph representing a direct current superimposition characteristic of a laminated coil according to a third embodiment.

FIG. 8 is schematic cross-sectional view of a laminated coil according to a fourth embodiment.

FIG. 9 is an exploded perspective view of a laminated coil according to a fourth embodiment.

FIG. 10 is schematic cross-sectional view of a laminated coil according to a fifth embodiment.

FIG. 11 is schematic cross-sectional view of a laminated coil according to a sixth embodiment.

FIG. 12 is an exploded perspective view of a laminated coil according to a sixth embodiment.

### BEST MODE FOR CARRYING OUT THE INVENTION

Embodiments of the present invention will be described below with reference to the attached drawings.

### First Embodiment

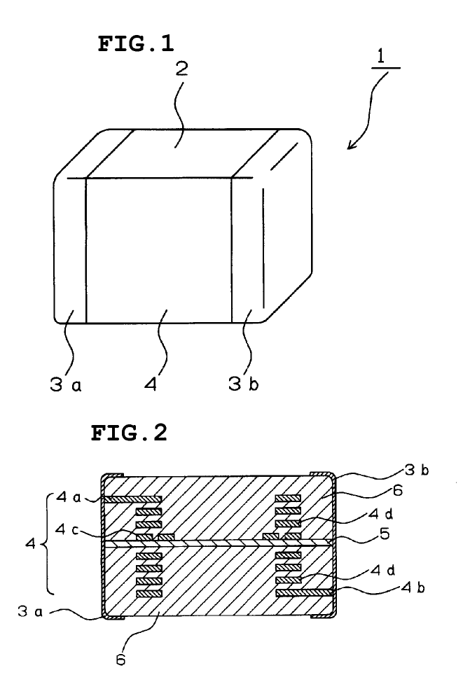

FIG. 1 is an external perspective view of a laminated coil according to a first embodiment of the present invention. FIG. 2 is a schematic cross-sectional view of the laminated coil. A laminated coil 1 includes a laminated body 2, external electrodes 3a and 3b provided on the surface of the laminated body 2 and coil conductors 4 embedded in the laminated body 2. The laminated body 2 is structured such that magnetic body sections 6 formed by stacking magnetic layers is disposed on both main surfaces of a non-magnetic body section. Inside the laminated body 2, the coil conductors 4 are embedded so as to formed one helical coil whose axial direction is the lamination direction.

The non-magnetic body section 5 and the magnetic body sections 6 are each constituted of at least one green sheet composed of non-magnetic material or magnetic material. A first end portion 4a of the coil conductors 4 is connected to the external electrode 3a and a second end portion 4b is connected to the external electrode 3b. A coil conductor 4c is provided on the non-magnetic body section 5. The coil number of the coil conductor 4c is greater than that of other coil conductors 4d provided on the green sheets being composed of magnetic material and constituting the magnetic body sections 6.

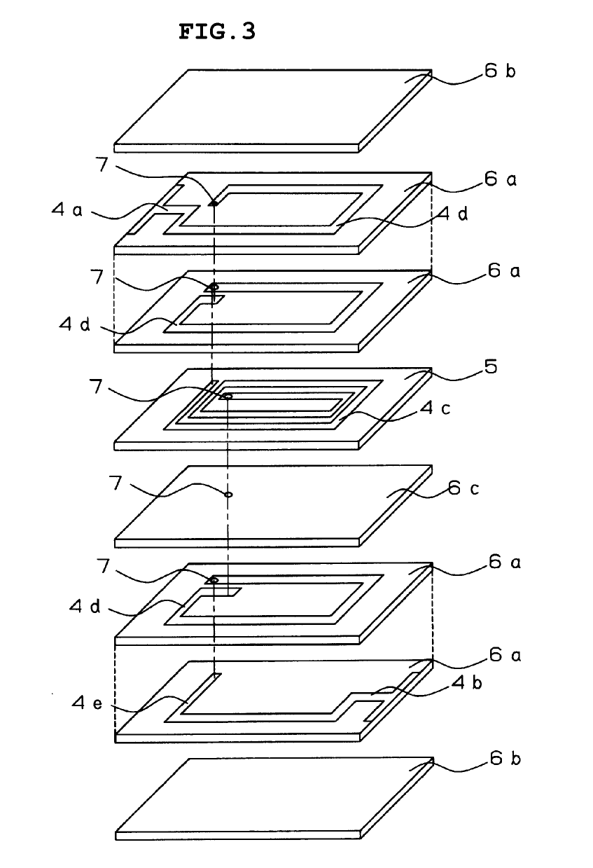

Next, a method of producing the laminated coil 1 will be described with reference to an exploded perspective view of the laminated coil 1 shown in FIG. 3. First, a method of producing green sheets to be stacked using magnetic material and non-magnetic material will be described.

In this embodiment, a Cu—Zn based material is used as a non-magnetic material. First, a raw material including 48 mol % of ferric oxide (Fe₂O₃), 43 mol % of zinc oxide (ZnO), and 9 mol % of copper oxide (CuO) is wet prepared by a ball mill for a predetermined amount of time. The obtained mixture is dried and ground. The obtained powder is calcinated at 750° C. for one hour. This ferrite powder is mixed with a binder resin, a plasticizer, a moistening agent, and a dispersant by a ball mill for a predetermined amount of time. Then, defoaming is carried out by depressurization to obtain slurry. The slurry is applied onto a substrate of PET film. Then, by drying, a ferrite green sheet that has a predetermined thickness and that is made of a non-magnetic material is produced.

A Ni—Cu—Zn based material is used as a magnetic material. A material including 48 mol % of Fe²O³, 20 mol % of ZnO, 9 mol % of CuO, and 23 mol % of nickel oxide (NiO) is used as raw material to obtain slurry by the same method as the above-described method employed for the non-magnetic material. The slurry is applied onto a substrate of PET film. Then, by drying, a ferrite green sheet that has a predetermined thickness and that is made of a magnetic material is produced.

The non-magnetic and magnetic ferrite green sheets produced as described above are cut into predetermined sizes to obtain ferrite sheet pieces. Then, through-holes are formed by a laser beam at predetermined positions on the ferrite green sheets so that, when the above-described green sheets are stacked, the coil conductors on the sheets are connected with each other to form the coil conductor. The relative magnetic permeability of each ferrite green sheet is 1 for the Cu—Zn based ferrite green sheet and 130 for the Ni—Cu—Zn based ferrite green sheet.

Next, as illustrated in FIG. 3, a coil conductor having a predetermined shape is produced by applying a conductive paste mainly consisting of Ag or an Ag alloy, such as Ag—Pd, by screen printing onto the ferrite green sheets on which coil conductors are formed. On a non-magnetic layer that is the green sheet 5 composed of the Cu—Zn based material, the coil conductor 4c having a coil number of two turns is formed. On a magnetic layer that is the green sheet 6a composed of the Cu—Zn based material, the coil conductor 4d having a coil number of one turn and a coil conductor 4e having a coil number of 0.5 turns are formed. Screen printing of the coil conductor is carried out so that through-holes 7 are formed at the end portions of the coil conductors 4c and 4d. At the same as carrying out the printing, conductive paste is filled inside the through-holes 7. The line thickness of the coil conductor 4c is smaller than that of the coil conductor 4d.

In a coil according to the present invention, a magnetic field extends from the axial center to the outer periphery of the coil is generated. If the diameter of the cross-sectional opening of the helical electrode formed by connecting the coil conductors on the green sheets is reduced, the magnetic field that passes through the axial center of the coil is disturbed. Thus, a possible defect in electric characteristics, such as a reduction in the inductance value, might occur. To reduce the disturbance of the magnetic field, the line width of the coil conductors having a great coil numbers is reduced. In addition to the above-described green sheets, a Ni—Cu—Zn based green sheet 6c having only a through-hole 7 filled with conductive paste and Ni—Cu—Zn based green sheets 6b for the exterior are produced.

These green sheets are stacked in the order shown in FIG. 3 and are pressure bonded at 45° C. at a pressure of 1.0 t/cm². By cutting the obtained laminated body into 3.2×1.6×0.8 mm pieces using a dicing apparatus, unfired bodies of the laminated coil are obtained. Binder removal and firing of these unfired bodies are carried out. The bodies are fired in a low oxygen atmosphere at 500° C. for 120 minutes for binder removal and are fired in an atmosphere of 890° C. for 150 minutes for firing. Finally, conductive paste mainly consisting of Ag is applied by immersion to the end surfaces of the laminated coil where the lead electrodes 4a and 4b are exposed. A laminated coil is obtained after forming external terminals by drying the bodies at 100° C. for 10 minutes and then baking at 780° C. for 150 minutes.

As shown in FIG. 3, the laminated coil according to the first embodiment has the non-magnetic body section 5 at substantially the middle in the lamination direction. Since the relative magnetic permeability of the non-magnetic body section 5 is one, or the same that of air, the structure of the laminated coil will appear as though the laminated coil is divided into two by air. Thus, the magnetic field inside the laminated coil cannot generate a closed magnetic path from the axial center of the coil to the outer peripheral area of the coil conductors. Since the magnetic field inside the non-magnetic body section 5 has a uniform distribution similar to that of air, a magnetic field that leaks from the non-magnetic body section 5 to the outside of the laminated coil is generated without the magnetic field concentrating in a manner such as that inside the magnetic body section 6. As a result, the magnetic saturation caused by concentration of the magnetic field inside the laminated coil is reduced.

According to this embodiment, the coil number of the coil conductor 4c on the non-magnetic body section 5 is greater than the coil number of the coil conductor 4d on the magnetic layer 6a. Since the strength of the generated magnetic field is increased when the coil number is increased, the magnetic field can be concentrated even more on the coil conductor on the non-magnetic body section 5. Thus, the magnetic field leaking from the non-magnetic body section 5 can be increased. Therefore, even when a high electrical current is applied to the coil conductors, magnetic saturation does not easily occur inside the laminated coil. Thus, the DC superimposition characteristic of the laminated coil can be improved. According to this embodiment, the non-magnetic body section 5 is constituted of one Cu—Zn based ferrite green sheet. However, the non-magnetic body section 5 may be constituted of a plurality of Cu—Zn based ferrite green sheets.

### Second Embodiment

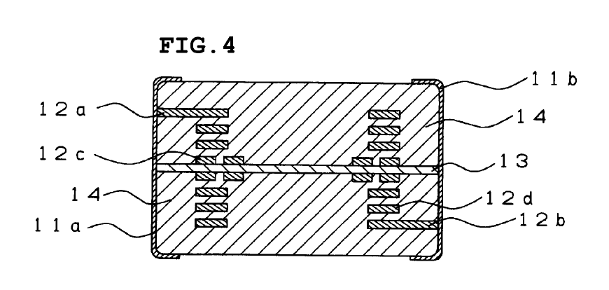

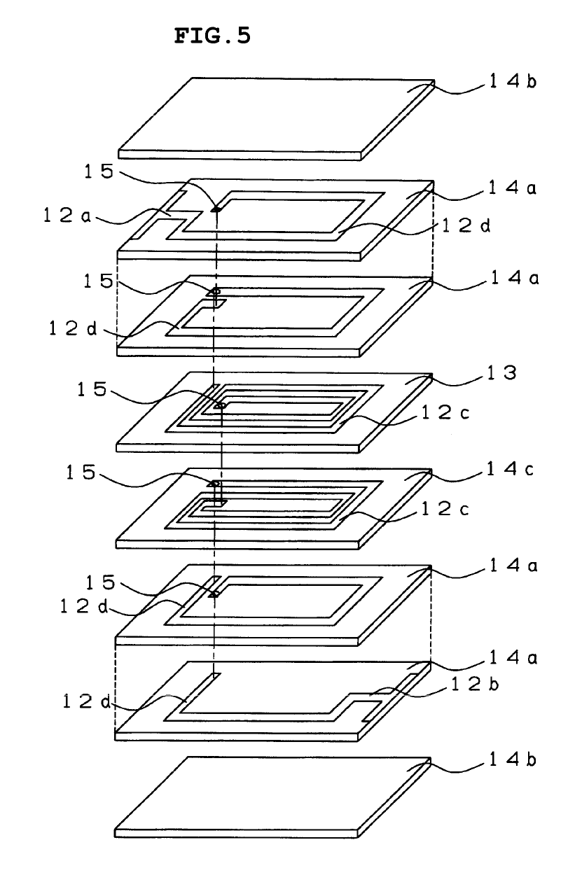

FIGS. 4 and 5 illustrate a schematic sectional view and an exploded perspective view, respectively, of a laminated coil according to a second embodiment of the present invention. According to this embodiment, above and below a non-magnetic body section 13, coil conductors 12c, whose coil number is greater than that of coil conductors 12d provided on a magnetic body section 14, are provided. The laminated coil according to this embodiment, similar to the laminated coil according to the first embodiment, is produced through steps of stacking ferrite green sheets including coil conductors in the order shown in FIG. 5, pressure compressing, dicing the sheets into chips, and, then, forming external terminal electrodes.

As shown in FIG. 5, by increasing the coil number of the coil conductors 12c that are provided above and below the non-magnetic body section 13, the magnetic field leaking outside the laminated coil can be increased more than that of the first embodiment. Thus, the magnetic saturation of the magnetic body section 14 can be reduced even more. Accordingly, the DC superimposition characteristic of the laminated coil can be improved even more.

### Third Embodiment

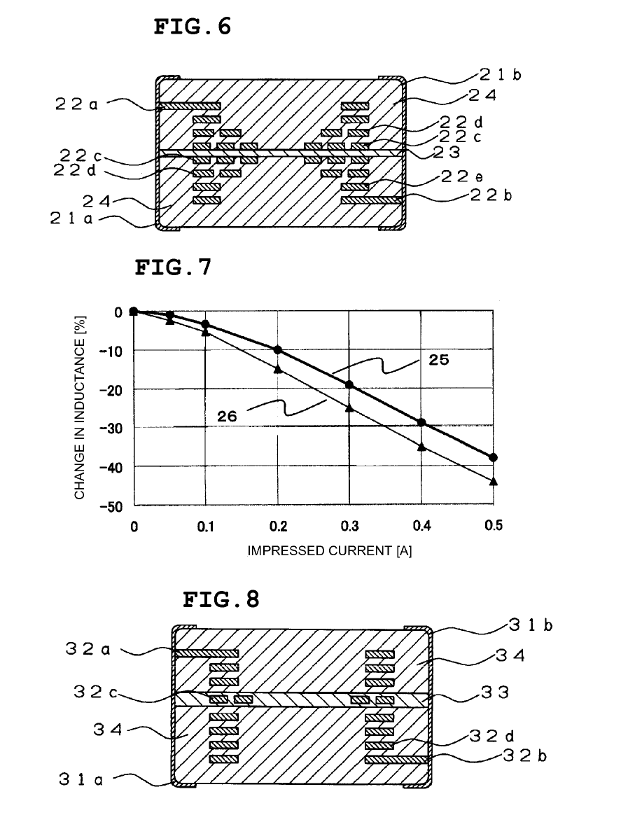

FIG. 6 illustrates a schematic cross-sectional view of a laminated coil according to a third embodiment of the present invention. According to this embodiment, coil conductors 22c provided above and below a non-magnetic layer 23 each have a coil number of three turns, and coil conductors 22d provided above and below the coil conductors 22c each have a coil number of two turns. By employing a laminated coil having a structure according to this embodiment, the magnetic field can be concentrated more at the vicinity of the non-magnetic layer 23. Thus, the magnetic saturation inside the laminated coil is reduced, and the DC superimposition characteristic of the laminated coil can be improved.

FIG. 7 illustrates the DC superimposition characteristic of the laminated coil according to this embodiment. FIG. 7 illustrates a characteristic 25 for a case in which the coil number of the coil conductors 22c and the coil conductors 22d is greater than that of another coil conductor 22e and a characteristic 26 for a known structure in which the coil numbers are not changed. The inductance value of the laminated coil when the value of the electric current applied to the coil conductors is small is 4.7 μH. The change in inductance represented by the vertical axis of the graph corresponds to a value obtained by dividing the reduction in the inductance value when the applied current is increased by the initial value, 4.7 μH. As described in this embodiment, by increasing the coil number of the coil conductors provided on the non-magnetic layer and/or the vicinity thereof, the DC superimposition characteristic can be improved, in particular, when the applied current is large.

### Fourth Embodiment

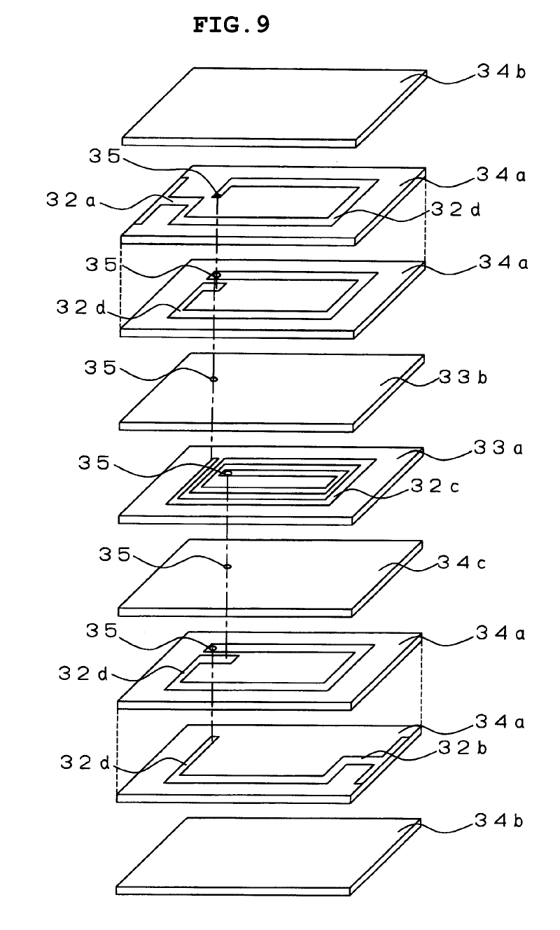

FIG. 8 illustrates a schematic cross-sectional view of a laminated coil according to a fourth embodiment. According to this embodiment, a coil conductor 32c having a coil number greater than that of a conductive pattern 32d provided on a magnetic body section 32 is formed inside a non-magnetic body section 33. FIG. 9 illustrates an exploded perspective view of the laminated coil according to this embodiment. As shown in FIG. 9, to embed the coil conductor 32c inside the non-magnetic body section 33, the coil conductor 32c is formed on a non-magnetic layer 33a, and then a non-magnetic layer 33b, not including a coil conductor, is stacked on the non-magnetic layer 33a. By employing a laminated coil having a structure according to this embodiment, the magnetic field can be concentrated inside the non-magnetic layer 33, and the leakage of magnetic field from the non-magnetic body section 33 to outside the laminated coil is increased. Therefore, magnetic saturation of the magnetic body sections is reduced, and the DC superimposition characteristic of the laminated coil can be improved.

### Fifth Embodiment

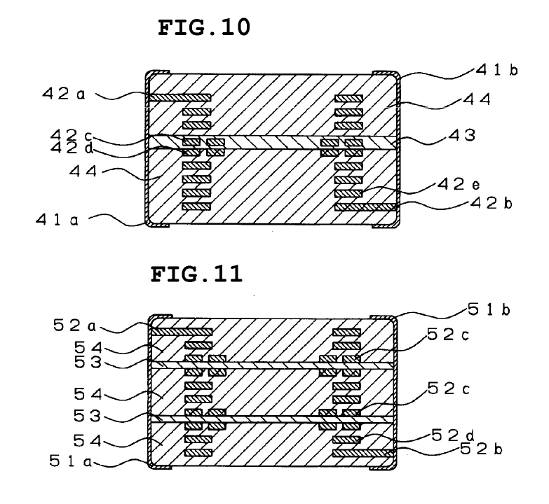

FIG. 10 illustrates a schematic cross-sectional view of a laminated coil according to a fifth embodiment of the present invention. According to this embodiment, coil conductors 42c and 42d are formed inside a non-magnetic body section 43 and on the non-magnetic body section 43, respectively. Since coil conductors according to this embodiment are provided inside and on the main surface of the non-magnetic body section 43, the magnetic field leaks even more from the non-magnetic body section 43 to the outside of the laminated coil. Thus, the effect of reducing magnetic saturation of the magnetic body section is increased, and the DC superimposition characteristic of the laminated coil can be improved even more.

The laminated coils according to the first to fifth embodiments each include a non-magnetic body section in the middle in the lamination direction of the laminated coil. However, even if the non-magnetic body section is provided at a position other than the center, the DC superimposition characteristic of the laminated coil can be improved.

### Sixth Embodiment

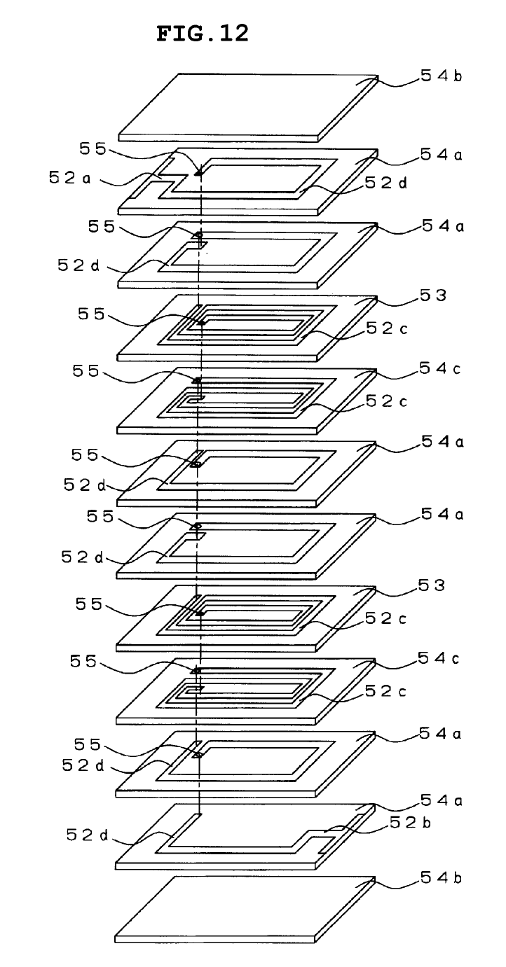

FIGS. 11 and 12 illustrate a schematic cross-sectional view and an exploded perspective view, respectively, of a laminated coil according to a sixth embodiment of the present invention. According to this embodiment, two layers of non-magnetic body sections 53 each having conductive patterns 52c provided on both sides are disposed inside the laminated coil. Each of the conductive patterns 52c has a coil number greater than that of a coil conductor 52d provided on a magnetic body sections 54. According to this embodiment, since two layers of the non-magnetic body sections 53 are provided, twice as much as the magnetic field generated when only one layer is provided leaks to the outside of the laminated coil. Therefore, the effect of reducing magnetic saturation of the magnetic body section is increased, and the DC superimposition characteristic of the laminated coil can be improved even more.

### Other Embodiments

The present invention is not limited to the above-described embodiments, and various modifications may be employed within the scope of the invention. In particular, the coil number and shape of the coil conductors according to the embodiments are examples, and the coil number and shape of the coil conductors are not limited thereto.

### INDUSTRIAL APPLICABILITY

As described above, the present invention may be employed to a laminated coil, such as a choke coil, and, in particular, is advantageous in that the DC superimposition characteristic is excellent.

1-6. (canceled)

7. A laminated coil comprising:
a laminated body including a non-magnetic body section and magnetic body sections disposed on both main surfaces of the non-magnetic body section, each of the magnetic body sections including a plurality of stacked magnetic layers, and the non-magnetic body section including a plurality of stacked non-magnetic layers; and
a coil including coil conductors provided on the magnetic body sections and the non-magnetic body section, the coil conductors being helically connected; wherein
the number of coil turns of the coil conductors provided on the non-magnetic body section is greater than the number of coil turns of the coil conductors provided on each layer other than the coil conductors provided on the non-magnetic body section.

8. The laminated coil according to claim 7, wherein the coil conductors provided on the non-magnetic body section are disposed on at least one of the main surfaces of the non-magnetic body section.

9. The laminated coil according to claim 8, wherein the coil conductors provided on the non-magnetic body section are disposed on both of the main surfaces of the non-magnetic body section.

10. The laminated coil according to claim 9, wherein the coil conductors provided on the non-magnetic body section are also provided inside the non-magnetic body section.

11. The laminated coil according to claim 8, wherein the coil conductors provided on the non-magnetic body section are also provided inside the non-magnetic body section.

12. The laminated coil according to claim 7, wherein a plurality of the non-magnetic body sections is provided inside the laminated body.

13. A laminated coil comprising:
a laminated body including a non-magnetic body section and magnetic body sections disposed on both main surfaces of the non-magnetic body section, each of the magnetic body sections including a plurality of stacked magnetic layers, and the non-magnetic body section including at least one non-magnetic layer; and
a coil including coil conductors provided on the magnetic body sections and the non-magnetic body section, the coil conductors being helically connected; wherein
the number of coil turns of the coil conductors provided on the non-magnetic body section is greater than the number of coil turns of the coil conductors provided on the magnetic body section.

14. The laminated coil according to claim 13, wherein the non-magnetic body section includes a plurality of stacked non-magnetic layers.

15. The laminated coil according to claim 14, wherein the coil conductors provided on the non-magnetic body section are disposed on at least one of the main surfaces of the non-magnetic body section.

16. The laminated coil according to claim 14, wherein the coil conductors provided on the non-magnetic body section are disposed on both of the main surfaces of the non-magnetic body section.

17. The laminated coil according to claim 15, wherein the coil conductors provided on the non-magnetic body section are also provided inside the non-magnetic body section.

18. The laminated coil according to claim 16, wherein the coil conductors provided on the non-magnetic body section are also provided inside the non-magnetic body section.

19. The laminated coil according to claim 13, wherein a plurality of the non-magnetic body sections is provided inside the laminated body.

20. The laminated coil according to claim 13, wherein the non-magnetic body section includes a single non-magnetic layer.

21. The laminated coil according to claim 20, wherein the coil conductors provided on the non-magnetic body section are disposed on at least one of the main surfaces of the non-magnetic body section.

22. The laminated coil according to claim 20, wherein the coil conductors provided on the non-magnetic body section are disposed on both of the main surfaces of the non-magnetic body section.

23. The laminated coil according to claim 13, wherein the coil conductors provided on the non-magnetic body section are also provided inside the non-magnetic body section.
